(19) United States
(12) Patent Application Publication
(10) Pub. No.: US 2025/0088286 A1
(43) Pub. Date: Mar. 13, 2025

(54) SYSTEM AND METHOD FOR IN-DEVICE INTERFERENCE MITIGATION

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Yi-Ling Chao, Sunnyvale, CA (US)

(21) Appl. No.: 18/821,715

(22) Filed: Aug. 30, 2024

Related U.S. Application Data
(60) Provisional application No. 63/611,289, filed on Dec. 18, 2023.
(60) Provisional application No. 63/592,588, filed on Oct. 24, 2023.
(60) Provisional application No. 63/588,945, filed on Oct. 9, 2023.
(60) Provisional application No. 63/581,735, filed on Sep. 11, 2023.

(51) Int. Cl. H04B 15/02; H04B 1/525; H04W 72/0446; H04W 84/12

(52) U.S. Cl. CPC H04B 15/02; H04B 1/525; H04W 72/0446; H04W 84/12

(57) ABSTRACT

Embodiments of a method and apparatus for communications are disclosed. In an embodiment, a communications device includes a controller configured to perform periodic or aperiodic in-device interference mitigation and a wireless transceiver configured to conduct wireless communications in response to the periodic or aperiodic in-device interference mitigation.

### CROSS-REFERENCE TO RELATED APPLICATIONS

This application is entitled to the benefit of U.S. Provisional Patent Application Ser. No. 63/581,735, filed on Sep. 11, 2023, U.S. Provisional Patent Application Ser. No. 63/588,945, filed on Oct. 9, 2023, U.S. Provisional Patent Application Ser. No. 63/592,588, filed on Oct. 24, 2023, and U.S. Provisional Patent Application Ser. No. 63/611,289, filed on Dec. 18, 2023, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless communications interference can affect wireless communication throughput. For example, wireless transmissions of in-device coexisting radio(s), such as, a Bluetooth transmitter may interfere wireless transmissions of with a WLAN (e.g., Wi-Fi) transmitter.

### SUMMARY

Embodiments of a method and apparatus for communications are disclosed. In an embodiment, a communications device includes a controller configured to perform periodic or aperiodic in-device interference mitigation and a wireless transceiver configured to conduct wireless communications in response to the periodic or aperiodic in-device interference mitigation. Other embodiments are also disclosed.

In an embodiment, the controller is further configured to generate a frame that includes in-device interference information, and the wireless transceiver is further configured to wirelessly transmit the frame to a second communications device.

In an embodiment, the frame includes a management frame or a control frame.

In an embodiment, the in-device interference information is contained in a header of the frame or a frame body of the frame.

In an embodiment, the in-device interference information includes a communications parameter restriction as a result of an existence or an occurrence of a wireless communications interference within the communications device, and the frame includes a management frame.

In an embodiment, the communications parameter restriction includes a reception parameter restriction of the communications device.

In an embodiment, the reception parameter restriction includes a bandwidth (BW) restriction, a Modulation Coding Scheme (MCS) restriction, a reception power restriction, a number of spatial streams (Nss) restriction, or one or more interfered 20 Megahertz (MHz) channels that are covered by the communications device's operating channel or a Basic Service Set (BSS) operating channel.

In an embodiment, the communications parameter restriction includes a transmission parameter restriction for transmission to the communications device.

In an embodiment, the transmission parameter restriction includes a bandwidth (BW) restriction, a Modulation Coding Scheme (MCS) restriction, a transmission power restriction, a number of spatial streams (Nss) restriction, or one or more interfered 20 Megahertz (MHz) channels that are covered by an operating channel of the communications device or a Basic Service Set (BSS) operating channel.

In an embodiment, the in-device interference information includes non-wireless activity service period (SP) information and optional transmission/reception parameter restriction within the non-wireless activity SP as a result of an existence or an occurrence of a wireless communications interference within the communications device.

In an embodiment, the in-device interference information includes an availability or unavailability time announcement as a result of an existence or an occurrence of a wireless communications interference within the communications device, and an availability announcement is contained in a header of the frame and an unavailability time announcement is contained in a frame body of the frame.

In an embodiment, the frame is a control frame and a transmit opportunity (TXOP) subfield in a Universal Signal Field (U-SIG) field of a trigger based (TB) Physical Layer Protocol Data Unit (PPDU) carrying the frame is set per Short Interframe Space (SIFS) and the responding PPDU transmission time less than a duration of a soliciting initial control frame (ICF) frame.

In an embodiment, the communications device includes a mobile wireless access point (AP) or a wireless non-AP station (STA).

In an embodiment, the communications device includes a wireless device that is compatible with an Institute of Electrical and Electronics Engineers (IEEE) 802.11 protocol.

In an embodiment, the communications device includes a wireless multi-link device (MLD), and the wireless transceiver is further configured to transmit a frame to a second wireless MLD through a wireless link between the wireless MLD and the second wireless MLD in response to the periodic or aperiodic in-device interference mitigation.

In an embodiment, a communications device includes a controller configured to generate a frame that includes in-device interference information contained in a header of the frame or a frame body of the frame, where the frame includes a management frame or a control frame, and a wireless transceiver configured to wirelessly transmit the frame to a second communications device.

In an embodiment, the in-device interference information includes a communications parameter restriction, wireless local area network (WLAN) activity service period (SP) information, or an availability or unavailability time announcement as a result of an existence or an occurrence of a wireless communications interference within the communications device.

In an embodiment, the communications device includes a wireless access point (AP) that is compatible with an Institute of Electrical and Electronics Engineers (IEEE) 802.11 protocol.

In an embodiment, a method for wireless communications involves at a wireless communications device, performing periodic or aperiodic in-device interference mitigation and from the wireless communications device, conducting wireless communications in response to the periodic or aperiodic in-device interference mitigation.

In an embodiment, the wireless communications device is compatible with an Institute of Electrical and Electronics Engineers (IEEE) 802.11 protocol.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a wireless device with multiple wireless transceivers in accordance with an embodiment of the invention.

FIG. 5 illustrates a frame format in accordance with an embodiment of the invention.

FIG. 6 illustrates a frame format in accordance with an embodiment of the invention.

FIG. 7 depicts a frame exchange sequence diagram between an AP and a station (STA).

FIG. 8 depicts a frame exchange sequence diagram between an AP and a STA.

FIG. 9 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

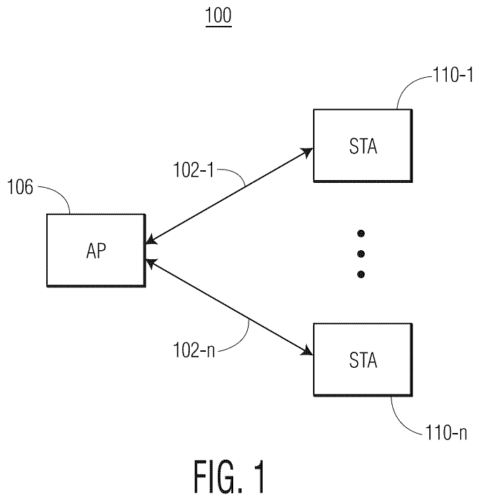

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

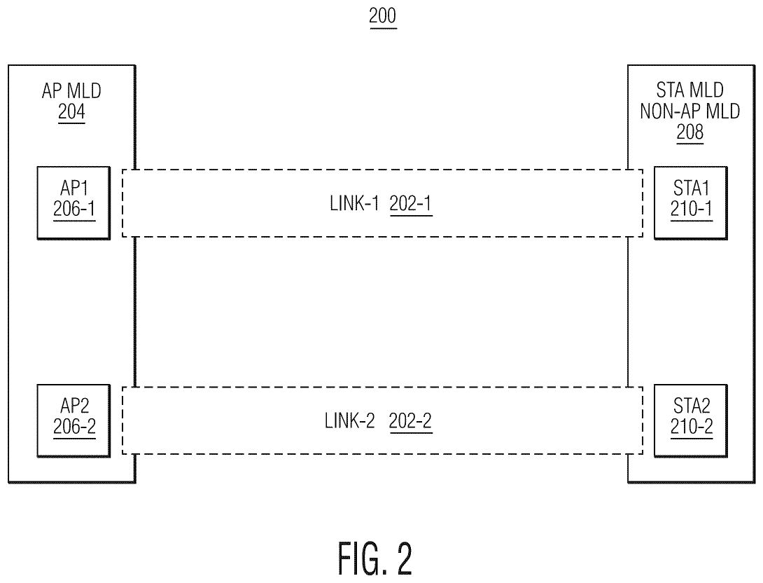

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

A wireless communications interference, such as In-device coexisting radio(s) (e.g., a Bluetooth transmitter), may interfere with a WLAN (e.g., Wi-Fi) transmitter because the WLAN (e.g., Wi-Fi) transmitter might not know for periodic activity or might not know for aperiodic activity beforehand when the interference may occur. A WLAN (e.g., Wi-Fi) device can announce that the device has one or more coexisting radios/transmitters when performing the association or after the in-device coexisting radio(s) is turned on or turned off. In some embodiments, the activity of coexisting radios/transmitters are link-level information. This information can help its connected WLAN (e.g., Wi-Fi) device to optimize rate adaptation in transmission. Knowing that a WLAN (e.g., Wi-Fi) receiver's error packets are resulted from a coexisting interference instead of a bad channel condition can improve wireless transmission throughput, for example, by preventing a WLAN (e.g., Wi-Fi) transmitter from dropping data packets, resulting in a lower data rate.

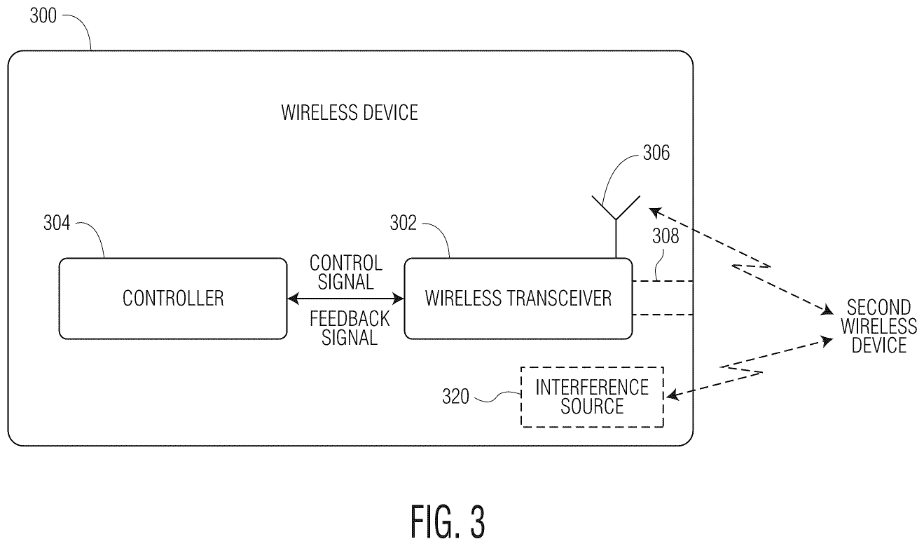

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some embodiments, an interference source 320 is located within the wireless device. For example, the interference source 320 may be an in-device coexisting transmitter/radio (e.g., a Bluetooth transmitter/radio) and/or other known interference source. In some embodiments, the wireless device 300 may further include a second wireless transceiver, and the interference source includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol (e.g., a Bluetooth communications protocol).

In some cases, for aperiodic (short-term) interference mitigation, a non-AP STA that is a transmit opportunity (TXOP) responder can indicate in a response frame, for how long it will be available, if known, and/or whether it will be unavailable after a specific point in time and, if known, for how long. A non-AP STA as a TXOP holder can indicate in a frame, for how long it will be available, if known, and/or whether it will be unavailable after a specific point in time and, if known, for how long. In some cases, for periodic (long term) interference mitigation, a STA use a management frame to announce its long-term restriction of the frame exchange (e.g., periodic unavailable time and receiver/transmitter (Rx/Tx) parameter restriction).

In some cases, for Non-primary Channel Access (NPCA) and Dynamic Sub-Channel Switch, the subchannel switch works as follows. The NPCA primary channel is defined. When the primary channel is occupied by an Overlapping BSS (OBSS) TXOP (OBSS TXOP 1), a STA/AP switch to a NPCA primary channel (e.g., one of the secondary channels of the AP's operating channel for the backoff) to perform backoff and the frame exchanges until the end of the OBSS TXOP 1. The medium recovery is needed when switching to a non-primary subchannel. The dynamic sub-channel switch (DSO) works as follows, when an AP acquires the medium access right, the AP solicits one or more STAs whose operating bandwidth (BW) is narrower than AP's operating BW to switch to the 20 channel(s) that are not covered by the STA's operating channel.

In accordance with an embodiment of the invention, the controller 304 is configured to perform periodic or aperiodic in-device interference mitigation, and the wireless transceiver 302 is configured to conduct wireless communications in response to the periodic or aperiodic in-device interference mitigation, for example, through the at least one antenna 306. In some embodiments, the controller 304 is further configured to generate a frame that includes in-device interference information, and the wireless transceiver 302 is further configured to wirelessly transmit the frame to a second communications device. In some embodiments, the frame includes a management frame or a control frame. In some embodiments, the in-device interference information is contained in a header of the frame or a frame body of the frame. In some embodiments, the in-device interference information includes a communications parameter restriction as a result of an existence or an occurrence of a wireless communications interference within the wireless device 300, and the frame includes a management frame. In some embodiments, the communications parameter restriction includes a reception parameter restriction of the wireless device 300. In some embodiments, the reception parameter restriction includes a bandwidth (BW) restriction, a Modulation Coding Scheme (MCS) restriction, a reception power restriction, and/or a number of spatial streams (Nss) restriction. In some embodiments, the communications parameter restriction includes a transmission parameter restriction for transmission to the wireless device 300. In some embodiments, the transmission parameter restriction includes a BW restriction, an MCS restriction, a transmission power restriction, and/or an Nss restriction. In some embodiments, the in-device interference information includes wireless local area network (WLAN) activity service period (SP) information as a result of an existence or an occurrence of a wireless communications interference within the wireless device 300. In some embodiments, the in-device interference information includes an availability or unavailability time announcement as a result of an existence or an occurrence of a wireless communications interference within the wireless device 300, and the availability time announcement is contained in a header of the frame and unavailable time is contained in a frame body of the frame. In some embodiments, the unavailability time announcement is contained in the frame body of the first frame of a TXOP transmitted by the TXOP responder and is used to indicate a transmit opportunity (TXOP) responder's available time. In some embodiments, the unavailability time announcement is contained in the frame body of the frames other than the first frame of a TXOP transmitted by the TXOP responder. In some embodiments, the wireless device 300 or the second communications device includes a wireless access point (AP) or a wireless non-AP station (STA). In some embodiments, the wireless device 300 is compatible with an Institute of Electrical and Electronics Engineers (IEEE) 802.11 protocol. In some embodiments, the wireless device includes a wireless multi-link device (MLD), the second communications device includes a second wireless MLD, and the wireless transceiver 302 is further configured to transmit the control frame for a wireless link to the second wireless MLD through the wireless link between the AP/STA of the wireless MLD in the wireless link and the STA/AP of the second wireless MLD in the wireless link.

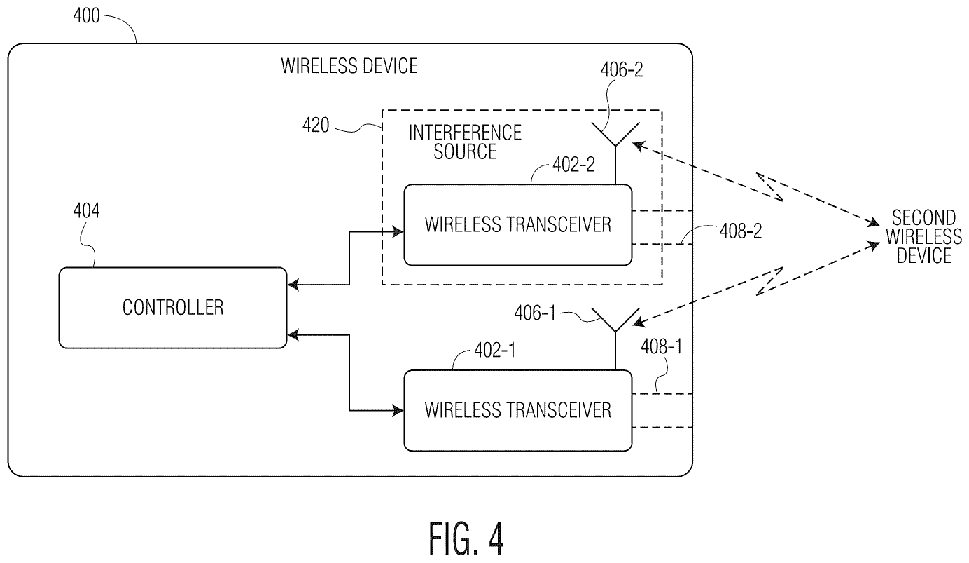

FIG. 4 depicts a wireless device 400 with multiple wireless transceivers 402-1, 402-2 in accordance with an embodiment of the invention. The wireless device 400 depicted in FIG. 4 may be an embodiment of the wireless device 300 depicted in FIG. 3. However, the wireless device 300 depicted in FIG. 3 is not limited to the embodiment depicted in FIG. 4. The wireless device 400 can be used in the wireless communications system 100 depicted in FIG. 1 and/or the multi-link communications system 200 depicted in FIG. 2. For example, the wireless device 400 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 4, the wireless device 400 includes the first wireless transceiver 402-1, the second wireless transceiver 402-2, a controller 404 operably connected to the wireless transceiver, a first antenna 406-1 operably connected to the first wireless transceiver 402-1, and a second antenna 406-2 operably connected to the second wireless transceiver 402-2. In some embodiments, the wireless device 400 may include one or more optional network ports 408-1, 408-2 operably connected to the wireless transceivers 402-1, 402-2. In some embodiments, at least one of the wireless transceivers 402-1, 402-2 includes a physical layer (PHY) device. The wireless transceivers 402-1, 402-2 may be any suitable type of wireless transceiver. For example, one of the wireless transceivers 402-1, 402-2 may be a WLAN transceiver (e.g., a transceiver compatible with an IEEE 802.11 protocol) while another one of the wireless transceivers 402-1, 402-2 may be a short-range transceiver (e.g., a transceiver compatible with a Bluetooth communications protocol). The controller may be configured to control the wireless transceivers 402-1, 402-2 (e.g., by generating one or more control signals) to process packets received through the antennas 406-1, 406-2 and/or the network ports 408-1, 408-2 and/or to generate outgoing packets to be transmitted through the antennas 406-1, 406-2 and/or the network ports 408-1, 408-2. In some embodiments, the wireless transceivers 402-1, 402-2 transmits one or more feedback signals to the controller 404. In some embodiments, the controller is implemented within a processor, such as a microcontroller, a host processor, a host, a DSP, or a CPU. In some embodiments, at least one of the wireless transceivers 402-1, 402-2 is implemented in hardware (e.g., circuits), software, firmware, or a combination thereof. The antenna may be any suitable type of antenna. For example, at least one of the antennas 406-1, 406-2 may be an induction type antenna such as a loop antenna or any other suitable type of induction type antenna. However, the antennas 406-1, 406-2 are not limited to induction type antennas. The network ports 408-1, 408-2 may be any suitable type of ports. For example, at least one of the network ports 408-1, 408-2 is an LAN port (e.g., an Ethernet port). Although the depicted wireless device 400 is shown in FIG. 4 with certain components and described with certain functionality herein, other embodiments of the wireless device 400 may include fewer or more components to implement the same, less, or more functionality. For example, although the wireless device 400 is shown in FIG. 4 as being connected in a certain topology, the network topology of the wireless device 400 is not limited to the topology shown in FIG. 4. In another example, in some embodiments, the wireless device includes multiple controllers with multiple wireless transceivers, a single antenna, more than two wireless transceivers, more than one antennas, and/or more than two network ports.

In accordance with an embodiment of the invention, the controller 404 is configured to generate a frame (e.g., a Physical Layer Convergence Protocol (PLCP) Protocol Data Unit (PPDUs), a beacon frame, or a management frame, etc.) that includes interference information indicating an existence or an occurrence of a wireless communications interference and the wireless transceiver 402-1 is configured to transmit the frame through the antenna 406-1. In some embodiments, the wireless device 400 is a wireless access point (AP) or a non-AP wireless station (STA) device. In some embodiments, the wireless device 400 is a component of a multi-link device (MLD)'s link.

In some embodiments, an interference source 420 is located within the wireless device 400 (e.g., a link of wireless device in the wireless device is a MLD with more than one link). For example, the interference source 420 may be an in-device coexisting transceiver/radio (e.g., a Bluetooth transceiver/radio) and/or other known interference source. In some embodiments, the wireless device further includes the second wireless transceiver 402-2, and the interference source 420 includes the second wireless transceiver 402-2 and/or the second antenna 406-2. In some embodiments, the first wireless transceiver 402-1 is compatible with an Institute of Electrical and Electronics Engineers (IEEE) 802.11 protocol, and the second wireless transceiver 402-2 is not compatible with the IEEE 802.11 protocol. In some embodiments, the second wireless transceiver 402-2 is compatible with a short range wireless communications protocol (e.g., a Bluetooth communications protocol).

In accordance with an embodiment of the invention, the controller 404 is configured to perform periodic or aperiodic in-device interference mitigation, and the wireless transceiver 402-1 is configured to conduct wireless communications in response to the periodic or aperiodic in-device interference mitigation, for example, through at least one antenna 406-1. In some embodiments, the controller 404 is further configured to generate a frame that includes in-device interference information, and the wireless transceiver 402-1 is further configured to wirelessly transmit the frame to a second communications device. In some embodiments, the frame includes a management frame or a control frame. In some embodiments, the in-device interference information is contained in a header of the frame or a frame body of the frame. In some embodiments, the in-device interference information includes a communications parameter restriction as a result of an existence or an occurrence of a wireless communications interference within the wireless device 400, and the frame includes a management frame. In some embodiments, the communications parameter restriction includes a reception parameter restriction of the wireless device 400. In some embodiments, the reception parameter restriction includes a BW restriction, an MCS restriction, a reception power restriction, an Nss restriction, and/or one or more interfered 20 Megahertz (MHz) channels that are covered by the wireless device's operating channel or a Basic Service Set (BSS) operating channel. In some embodiments, the communications parameter restriction includes a transmission parameter restriction for transmission to the wireless device 400. In some embodiments, the transmission parameter restriction includes a BW restriction, an MCS restriction, a transmission power restriction, an Nss restriction, and/or one or more interfered 20 Megahertz (MHz) channels that are covered by an operating channel of the wireless device or a Basic Service Set (BSS) operating channel. In some embodiments, the in-device interference information includes non-wireless activity service period (SP) information and optional transmission/reception parameter restriction within the non-wireless activity SP as a result of an existence or an occurrence of a wireless communications interference within the wireless device 400. In some embodiments, the in-device interference information includes an availability or unavailability time announcement as a result of an existence or an occurrence of a wireless communications interference within the wireless device 400, and an availability announcement is contained in a header of the frame and an unavailability time announcement is contained in a frame body of the frame. In some embodiments, the frame is a control frame and a transmit opportunity (TXOP) subfield in a Universal Signal Field (U-SIG) field of a trigger based (TB) Physical Layer Protocol Data Unit (PPDU) carrying the frame is set per Short Interframe Space (SIFS) and the responding PPDU transmission time less than a duration of a soliciting initial control frame (ICF) frame. In some embodiments, the availability information of a device is contained in a header of the frame as the device's first responding frame of a TXOP and the unavailable information of a device is contained in a frame body of the device's responding frame being or being not the device's first responding frame of a TXOP. In some embodiments, instead of announcing the unavailability time, the restricted Tx/Rx parameters within the restricted time period when restricted Tx/Rx parameters are applied are announced in the frame body. In some embodiments, the wireless device 400 or the second communications device includes a wireless access point (AP) or a wireless non-AP station (STA). In some embodiments, the wireless device 400 is compatible with an Institute of Electrical and Electronics Engineers (IEEE) 802.11 protocol. In some embodiments, the wireless device 400 or the second communications device includes a mobile wireless access point (mobile AP) or a wireless non-AP station (STA). In some embodiments, the wireless device 400 is compatible with an Institute of Electrical and Electronics Engineers (IEEE) 802.11 protocol. In some embodiments, the wireless device 400 includes a STA/AP affiliated with a wireless multi-link device (MLD), the second communications device includes a STA/AP affiliated with a second wireless MLD, and the wireless transceiver 402-1 is further configured to transmit the control frame for a wireless link to the second wireless MLD through the wireless link between the AP/STA of the wireless MLD in the wireless link and the STA/AP of the second wireless MLD in the wireless link.

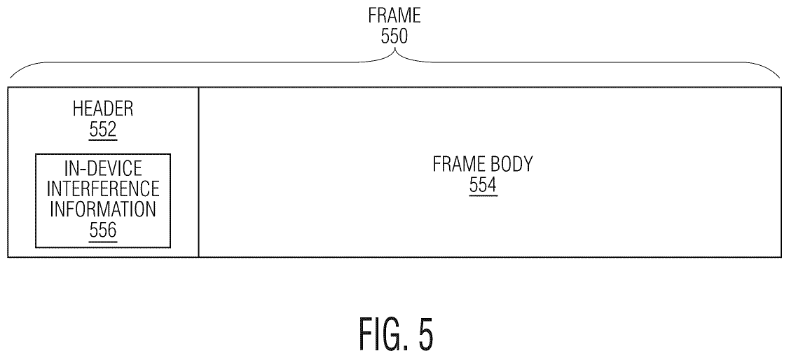

FIG. 5 illustrates a frame format 550 in accordance with an embodiment of the invention. The frame format 550 illustrated in FIG. 5 can be used for communications by the wireless communications system 100 depicted in FIG. 1, the multi-link (ML) communications system 200 depicted in FIG. 2, the wireless device 300 depicted in FIG. 3, and/or the wireless device 400 depicted in FIG. 4. In the embodiment depicted in FIG. 5, the frame format 550 includes a header 552 that may contain header information and a frame body 554 that may contain frame data. In some embodiments, the frame format 550 contains one or more additional fields with additional information. In the embodiment depicted in FIG. 5, the header 552 contains in-device interference information 556. In some embodiments, the frame 550 is a management frame or a control frame. In some embodiments, the in-device interference information 556 includes a communications parameter restriction as a result of an existence or an occurrence of a wireless communications interference within a wireless device. In some embodiments, the communications parameter restriction includes a reception parameter restriction of a wireless device. In some embodiments, the reception parameter restriction includes a BW restriction, an MCS restriction, a reception power restriction, and/or an Nss restriction. In some embodiments, the communications parameter restriction includes a transmission parameter restriction for transmission to a wireless device. In some embodiments, the transmission parameter restriction includes a BW restriction, an MCS restriction, a transmission power restriction, and/or an Nss restriction. In some embodiments, the in-device interference information 556 includes non-WiFi activity service period (SP) information as a result of an existence or an occurrence of a wireless communications interference within a wireless device. In some embodiments, the restricted Tx/Rx parameters are applied to the periodic non-WiFi activity SP defined by start time of periodic non-WiFi activity SP, interval of non-WiFi activity SP, the duration of non-WiFi activity SP. In some embodiments, the in-device interference information 556 includes an availability or unavailability time announcement as a result of an existence or an occurrence of an aperiodic wireless communications interference within a wireless device, and the availability or unavailability time announcement is contained in a header of the frame or a frame body of the frame. In some embodiments, the availability information of a device is contained in a header of the frame as the device's first responding frame of a TXOP and the unavailable information of a device is contained in a frame body of the device's soliciting control frame being the device's first soliciting frame, responding control frame being or being not the device's first responding frame of a TXOP. In some embodiments, instead of announcing the unavailability time, the restricted Tx/Rx parameters and the restricted time period when restricted Tx/Rx parameters are applied are announced in the frame body of the control frame. In some embodiments, the availability or unavailability time announcement is contained in a MAC header of the frame and is used to indicate a transmit opportunity (TXOP) responder's available time.

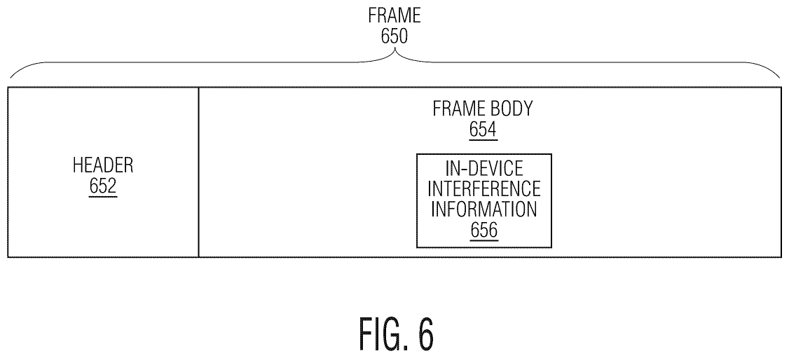

FIG. 6 illustrates a frame format 650 in accordance with an embodiment of the invention. The frame format 650 illustrated in FIG. 6 can be used for communications by the wireless communications system 100 depicted in FIG. 1, the multi-link (ML) communications system 200 depicted in FIG. 2, the wireless device 300 depicted in FIG. 3, and/or the wireless device 400 depicted in FIG. 4. In the embodiment depicted in FIG. 6, the frame format 650 includes a header 652 that may contain header information and a frame body 654 that may contain frame data. In some embodiments, the frame format 650 contains one or more additional fields with additional information. In the embodiment depicted in FIG. 6, the frame body 654 contains in-device interference information 656. In some embodiments, the frame 650 is a management frame or a control frame. In some embodiments, the in-device interference information 656 includes a communications parameter restriction as a result of an existence or an occurrence of a wireless communications interference within a wireless device. In some embodiments, the communications parameter restriction includes a reception parameter restriction of a wireless device. In some embodiments, the reception parameter restriction includes a BW restriction, an MCS restriction, a reception power restriction, and/or an Nss restriction. In some embodiments, the communications parameter restriction includes a transmission parameter restriction for transmission to a wireless device. In some embodiments, the transmission parameter restriction includes a BW restriction, an MCS restriction, a transmission power restriction, and/or an Nss restriction. In some embodiments, the in-device interference information 656 includes non-WiFi activity service period (SP) information as a result of an existence or an occurrence of a wireless communications interference within a wireless device. In some embodiments, the in-device interference information 656 includes an availability or unavailability time announcement as a result of an existence or an occurrence of a wireless communications interference within a wireless device. In some embodiments, instead of announcing the unavailability time, the restricted Tx/Rx parameters and/or the restricted time period (non-WiFi activity period) when restricted Tx/Rx parameters are applied are announced in the frame body. In some embodiments, the availability or unavailability time announcement is used to indicate a TXOP responder's available time.

Some implementations of long term (periodic) coexistence information notification, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, reception or receiver (Rx) parameter restriction per non-WiFi radio activity is implemented. In some embodiments, a STA notifies its Rx parameter restriction per its non-wifi radio activity to its peer device by using a unicast management frame (e.g., an association response frame, a Tunneled Direct Link Setup (TDLS) or other point-to-point (P2P) related establishment frame, and/or a newly defined Action frame). In some embodiments, the peer device as the TXOP holder (AP or STA) selects appropriate transmission or transmitter (Tx) parameters to transmit its Physical Layer Protocol Data Units (PPDUs) to the STA such that the STA's Rx parameters satisfy the STA's requirement. In some embodiments, the Rx parameters may be (but not be restricted to) bandwidth (BW), Modulation Coding Scheme (MCS) restriction (maximal MCS, minimal MCS), the Rx power, the number of spatial streams (Nss) within the non-wifi radio activity service periods (SPs). In some embodiments, the Rx parameters may be (but not be restricted to) BW, MCS restriction (maximal MCS, minimal MCS), the Rx power, the useful channel (or the unavailable 20 MHz channel bitmap covered by the STA's operating channel or BSS operating channel), and/or the Nss without the defined non-wifi radio activity SPs. In some embodiments, an AP notifies its Rx parameter restriction per its non-wifi radio activity to its peer device(s) by using a broadcast and/or unicast management frame (e.g., a beacon frame, a probe response frame, an association response frame or other action frame). In some embodiments, the peer device (e.g., an associated STA) selects appropriate Tx parameters to transmit its PPDUs to the STA so that the STA's Rx parameters satisfy the AP's requirement. In some embodiments, the Rx parameters may be (but not be restricted to) BW, MCS restriction (maximal MCS, minimal MCS), the Rx power, the Nss within the non-wifi radio activity SPs. In some embodiments, the Rx parameters may be (but not be restricted to) BW, MCS restriction (maximal MCS, minimal MCS), the Rx power, and/or the Nss without the defined non-wifi radio activity SPs. In some embodiments, the non-wifi radio activity SPs when Rx restricted parameters are applied are also announced. In some embodiments, the restricted Tx/Rx parameters are applied to a non-WiFi activity SP. In some embodiments, instead of announcing the unavailability time, the restricted Tx/Rx parameters and/or the restricted time period when restricted Tx/Rx parameters are applied are announced in the frame body.

In some embodiments, transmission or transmitter Tx parameter restriction per non-WiFi radio activity is implemented. In some embodiments, a STA notifies its Tx parameter restriction per its non-wifi radio activity by using a unicast management frame (e.g., an association response frame and/or a newly defined action frame). In some embodiments, an associated AP selects the Tx parameters in a Trigger frame for the STA per STA's request. In some embodiments, in a first option, the Tx parameters may be whether a trigger based (TB) PPDU can be solicited by the AP and the frame type being carried in the TB PPDU if the solicited TB PPDU is allowed within the non-WiFi radio activity SPs. The Tx parameters may be (but not be restricted) BW, the location of useful channel (or unavailable channel bitmap within STA's operating channel or BSS operating channel), MCS restriction (maximal MCS, minimal MCS), the Tx power, and/or the Nss within the non-wifi radio activity SPs. In some embodiments, in a second option, the Tx parameters may be whether a TB PPDU can be solicited by the AP and the frame type being carried in the TB PPDU (responding frame only or any frame) if the solicited TB PPDU is allowed without the defined non-wifi radio activity SPs. The Tx parameters may be (but not be restricted) BW, the location of useful channel (or unavailable channel bitmap within the STA's operating channel or BSS operating channel), MCS restriction (maximal MCS, minimal MCS), the Tx power, and/or the Nss without the defined non-wifi radio activity SPs. In some embodiments, the non-wifi radio activity SPs when Tx restricted parameters are applied are also announced. In some embodiments, the restricted Tx/Rx parameters are applied to a non-WiFi activity SP. In some embodiments, instead of announcing the unavailability time, the restricted Tx/Rx parameters and/or the restricted time period when restricted Tx/Rx parameters are applied are announced in the frame body. In some embodiments, besides announcing the unavailability time, the restricted Tx/Rx parameters and/or the restricted time period when restricted Tx/Rx parameters are applied are also announced in the frame body.

Some operations with interfered channel covering primary 20 Megahertz (MHz) channel, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described. In some embodiments, when an AP's interfered channel of a periodic in-device non-WiFi radio activity SP covers the primary 20 MHz channel, the AP and STAs can switch to the non-primary subchannel to perform the frame exchanges until the end of the non-WiFi radio activity SP. In some embodiments, when an AP detects/figures out that its aperiodic activity of its in-device non-WiFi radio covering the primary subchannel will happen, the AP may switch to the non-primary subchannel together with the non-AP STAs to perform the frame exchanges until the end of the aperiodic activity. The AP may notify the STAs to perform the subchannel switch before the aperiodic activity. In some embodiments, when a STA's interfered channel of a periodic in-device non-WiFi radio activity SP covers the primary 20 MHz channel, the STA can switch to the non-primary subchannel to perform the frame exchanges with an AP until the end of the non-WiFi radio activity SP. In some embodiments, one option is that the following restriction is applied, i.e., the STA does not initiate the frame exchanges with the AP in the non-primary subchannel.

Some primary 20 MHz channel operations with in-device non-wifi radio, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, after a backoff counter in the primary 20 MHz channel becomes 0, an AP may transmit a downlink (DL) multi-user (MU) PPDU (e.g., a DL single-user (SU) PPDU or a DL MU PPDU with single resource unit (RU)) to a STA if the following are true: that such PPDU is within the STA's periodic non-WiFi activity SP, that the PPDU or the related RU in MU PPDU does not cover the STA's periodic interfered 20 MHz channel(s), and that the primary 20 MHz channel is not covered by the STA's interfered 20 MHz channel(s), or that the primary 20 MHz channel is not covered by the STA's interfered 20 MHz channel(s) and the PPDU is not dynamic punctured.

In some embodiments, after a backoff counter in the primary 20 MHz channel becomes 0, an AP may solicit a UL Single User (SU)/TB PPDU from a STA if the following are true: that such PPDU is within the STA's periodic non-WiFi activity SP, the PPDU or the related RU in an MU PPDU does not cover the STA's periodic interfered 20 MHz channel(s), and that the primary 20 MHz channel is not covered by the STA's interfered 20 MHz channel(s), or the primary 20 MHz channel is not covered by the STA's interfered 20 MHz channel(s) and the PPDU is not dynamic punctured.

In some embodiments, after a backoff counter in the primary 20 MHz channel becomes 0, an STA may transmit a DL DU PPDU with a single resource unit (RU) or a UL SU PPDU if the following are true: that such PPDU is within the STA's periodic non-WiFi activity SP, and that the PPDU or the related RU in a MU PPDU does not cover the AP's periodic interfered 20 MHz channel(s).

Some implementations of In-device Non-wifi Radio Notification, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, when a STA supports (and enables) a Non-primary Channel Access (NPCA) operation and has active in-device non-WiFi radio, the STA can announce the interfered 20 MHz channel(s) that are covered by the BSS operating channel if an associated AP enables the non-primary subchannel switch operation. The interfered 20 MHz channel(s) may not be covered by the STA's operating channel. In some embodiments, the interfered 20 MHz channel(s) can be reported by the periodic non-WiFi activity or non-periodic non-WiFi activity.

Some subchannel switch operations with in-device non-wifi radio, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, when the primary subchannel is busy because of an OBSS TXOP, an AP may transmit a DL MU PPDU (a DL SU PPDU or a DL MU PPDU with single RU) to a STA on a NPCA primary channel after a backoff counter in the non-primary subchannel becomes 0 if the following are true: that such PPDU is within the STA's periodic non-WiFi activity SP, that the PPDU or the related RU in an MU PPDU does not cover the STA's periodic interfered 20 MHz channel(s), that the PPDU satisfies the puncture requirement, and that the NPCA primary channel is not covered by the STA's interfered 20 MHz channel(s).

In some embodiments, when the primary subchannel is busy because of an OBSS TXOP, an AP may trigger a STA to transmit a TB PPDU through the NPCA primary channel after a backoff counter in the NPCA primary channel becomes 0 if the following are true: that such PPDU is within the STA's periodic non-WiFi activity SP, that the related RU for the STA in the TB PPDU does not cover the STA's periodic interfered 20 MHz channel(s), that the RU satisfies the puncture requirement, and that the NPCA primary channel is not covered by the STA's interfered 20 MHz channel(s).

In some embodiments, when the primary subchannel is busy because of an OBSS TXOP, an STA may transmit a UL SU PPDU (e.g., a UL MU PPDU with a single RU) to its associated AP on an NPCA primary channel after a backoff counter in the non-primary subchannel becomes 0 if the following are true: that such PPDU is within the AP's periodic non-WiFi activity SP, that the PPDU or the related RU in an MU PPDU does not cover the AP's periodic interfered 20 MHz channel(s), that the PPDU satisfies the puncture requirement, and that the NPCA primary channel is not covered by the AP's interfered 20 MHz channel(s).

In some embodiments, when a STA supports (and enables) dynamic channel switch and has an active in-device non-WiFi radio, the STA can announce the interfered 20 MHz channel(s) that are covered by the BSS operating channel. The interfered 20 MHz channel(s) may not be covered by the STA's operating channel. The interfered 20 MHz channel(s) can be reported by the periodic non-WiFi activity or non-periodic non-WiFi activity.

Some implementations of dynamic channel switch with in-device non-wifi radio, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, an AP will not trigger a STA to transmit a TB PPDU after the dynamic channel switch if the following are true: that such triggered PPDU is within a STA's periodic non-WiFi activity SP, and that the interfered 20 MHz channels of the STA's periodic non-WiFi activity SP covers (or partly covers) the RU allocated to the STA.

Some implementations of short term (aperiodic) coexistence information notification, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows.

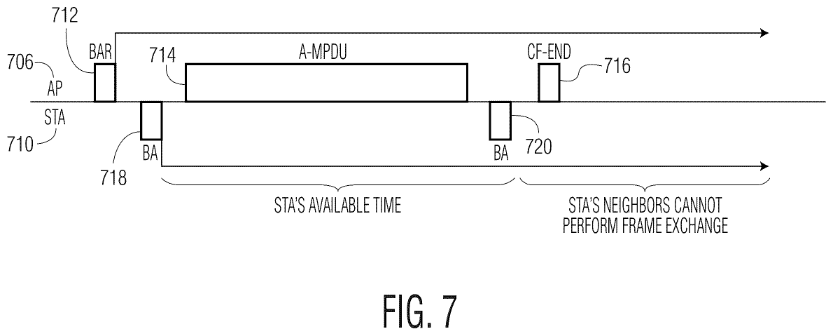

If the frame body of a unicast frame carries the available time of a responder, the neighbors of a TXOP responder may not be able to use the medium efficiently. A Contention Free (CF)-End may not help the neighbors of the TXOP responder when the TXOP holder is an AP. FIG. 7 depicts a frame exchange sequence diagram between an AP 706 and a STA 710. In the frame exchange sequence diagram depicted in FIG. 7, the AP 706 may be implemented the same as or similar to the AP 106 depicted in FIG. 1 and/or the AP 206-1 or 206-2 depicted in FIG. 2, while the STA 510 may be implemented the same as or similar to the STA 110-1, . . . , or 110-n depicted in FIG. 1 and/or the STA 210-1 or 210-2 depicted in FIG. 2, respectively. In the frame exchange sequence diagram depicted in FIG. 7, the AP 706 is the transmit opportunity (TXOP) holder. A block acknowledgement request (BAR) frame, an MU-RTS frame, or a BSRP Trigger frame 712 (with BAR as example in FIG. 7) may be sent by the AP 706 to reserve the TXOP, and a block acknowledgement (BA), CTS or “Multi-STABA”/“QoS Null” frame 718 respectively may be sent by the STA 710 in response to the BAR frame, the MU-RTS frame, or the BSRP Trigger frame 712. The AP may transmit an Aggregated Mac Protocol Data Unit (A-MPDU) 714 and the STA may transmit a BA frame 720 back to the AP. A CF-End frame 716 may be transmitted by the AP. The frame body of a unicast frame carries the available time of the STA 710, the neighbors of the STA 710 may not be able to use the medium efficiently. The CF-End frame does not help the neighbors of the TXOP responder, which is the STA 710, when the TXOP holder is an AP. Specifically, after the BA frame 720 is transmitted, the STA's neighbors cannot perform frame exchanges.

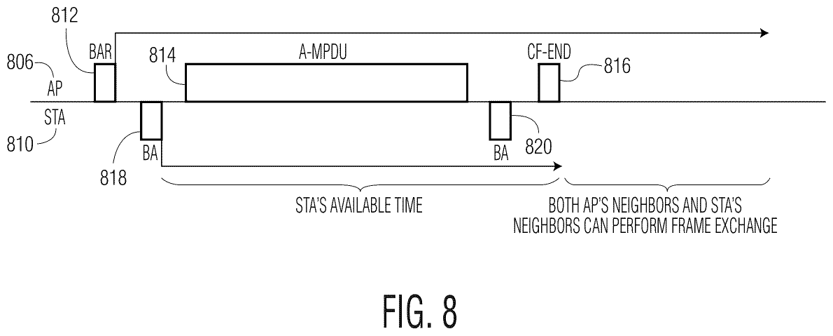

Using the Duration field to indicate the available time, the medium usage efficiency can be improved. FIG. 8 depicts a frame exchange sequence diagram between an AP 806 and a STA 810. In the frame exchange sequence diagram depicted in FIG. 8, the AP 806 may be implemented the same as or similar to the AP 106 depicted in FIG. 1 and/or the AP 206-1 or 206-2 depicted in FIG. 2, while the STA 810 may be implemented the same as or similar to the STA 110-1, . . . , or 110-n depicted in FIG. 1 and/or the STA 210-1 or 210-2 depicted in FIG. 2, respectively. In the frame exchange sequence diagram depicted in FIG. 8, the AP 806 is the transmit opportunity (TXOP) holder. A BAR frame, an MU-RTS frame, or a BSRP Trigger frame 812 (with BAR in FIG. 8 as example) may be sent by the AP 806 to reserve the TXOP, and a BA. CTS or “Multi-STABA”/“QoS Null” frame 818 (BA in the figure as example) may be sent by the STA 810 in response to the BAR frame, the MU-RTS frame, or the BSRP Trigger frame 812. The AP may transmit an A-MPDU 814 and the STA may transmit a BA frame 820 back to the AP. A CF-End frame 816 may be transmitted by the AP. With the Duration to indicate the available time, the medium usage efficiency can be improved. Specifically, after the BA frame 820 is transmitted, both the AP's neighbors and the STA's neighbors can perform frame exchanges.

The Duration (e.g., the time duration to indicate the available time) in a MAC header may not be suitable when multiple STAs are the TXOP responders when multiple TXOP responders transmit clear to send (CTS) frames, Multi-STA BA frames, or other frames with the different values in their Duration fields of the MAC headers.

In some embodiments, the Duration in a MAC header is used to indicate a TXOP responder's available time when a single TXOP responder is solicited. In some embodiments, if only one STA is solicited by an Initial control frame (ICF) and the responding PPDU's PHY header includes a TXOP subfield, the responder can use the Duration field in the responding frame to set the TXOP subfield in a Universal Signal Field (U-SIG) field of the responding PPDU. In some embodiments, multiple CTSs are solicited by an MU-RTS addressed to multiple STAs. In some embodiments, a trigger based (TB) PPDU from multiple STAs is solicited by an ICF addressed to multiple STAs. In some embodiments, in a first option, the resource units (RUs) of more than one STA cannot be in the same frequency channel (e.g., the same 20 MHz channel), if at least one STA reports its available time, and the TXOP subfield in the U_SIG field in a TB PPDU's PHY header is set per Duration in the MAC header of the carried frame(s). In some embodiments, in a second option, the time duration (e.g., the time duration to indicate the available time) in the PHY header is set per Short Interframe Space (SIFS) and the responding PPDU Tx time less than the Duration of the soliciting ICF frame (e.g., the sum of SIFS and the responding PPDU Tx time minus the Duration of the soliciting ICF frame) whose result in unit of microsecond is changed to the time in unit of 8 us or 512 us.

In some embodiments, the frame body or a high efficiency (HE) Control field in a frame header is used to indicate the TXOP responder's available time.

In some embodiments, when an AP as the TXOP holder receives a responding frame from an TXOP responder with a Duration field indicating a smaller TXOP duration, the AP may still use the original TXOP duration to set the Duration field in its transmitted frame to the TXOP responder under the condition that the TXOP holder will perform the frame exchanges with the other TXOP responders later in the TXOP. Otherwise, the AP may use the responding STA's available time as the TXOP remaining time starting from the ending time of the responding PPDU.

A mobile AP may have an in-device non-WiFi radio and may have its WiFi radio unavailable for some time. In addition, a mobile AP may have multiple peer devices. In some embodiments, a mobile AP that is a TXOP responder can indicate in a response frame, 1) for how long it will be available, if known, and/or, 2) whether it will be available/unavailable after a specific point in time and, if known, for how long. In another variant, this technique is also extended to a normal AP. In some embodiments, a mobile AP as a TXOP holder can indicate in a broadcast frame (or a unicast frame), 1) for how long it will be available, if known, and/or 2) whether it will be available/unavailable after a specific point in time and, if known, for how long. In another variant, this technique is also extended to a normal AP.

In some embodiments, instead of aperiodic unavailable time, a TXOP responder may announce the Tx/Rx parameter restriction with an aperiodic time when a non-WiF radio is active. In some embodiments, such announcement is embedded or included in the frame body of a control frame. In some embodiments, such announcement is embedded or included in the frame body of a Management frame.

Some implementations of management frames for aperiodic coexistence information announcement, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, a STA transmits its newly defined Action frame (e.g., an Unavailable Information Announcement frame) to report its aperiodic unavailable time through the Action frame. In some embodiments, a STA transmits its newly defined Action no Ack frame (e.g., an Unavailable Information Announcement frame) to report its aperiodic unavailable time through the Action no Ack frame when the STA is solicited by a Trigger frame. In some embodiments, an AP transmits its aperiodic unavailable time through a Beacon frame or a broadcast Action frame (e.g., an Unavailable Information Announcement frame).

Some implementations of In-device Interference Mitigation under Enhanced Multi-Link-Single-Radio (EMLSR)/Enhanced Multi-Link-Multi-Radio (EMLMR), dynamic subband/subchannel operation (DSO), Non-Primary Channel Access (NPCA), for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described as follows. In some embodiments, MU-Request to Send (RTS)+CTS and Buffer Status Report Poll (BSRP) Trigger+Quality of Service (QoS) Null are used for link switch while MU-RTS+Multi-STA BA or BSRP Trigger+Multi-STA BA (or a newly defined control frame) are used to indicate available time and/or the unavailable time besides link switch, low capability mode switch to high capability mode switch, DSO, NPCA operation. In some embodiments, another frame exchange (BAR+BA, A-MPDU+BA, newly defined soliciting control frame+newly defined responding control frame) other than the initial frame exchange to request the radio switch is used to indicate available time in the TXOP and and/or the future available/unavailable time.

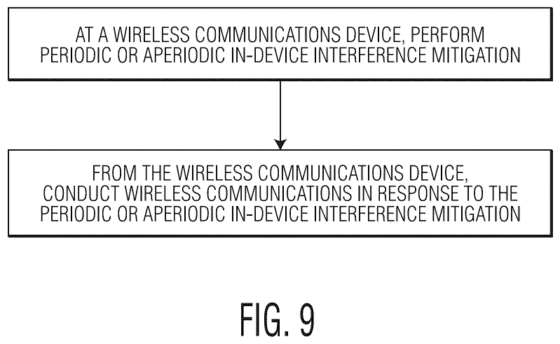

FIG. 9 is a process flow diagram of a method for wireless communications in accordance with an embodiment of the invention. At block 902, at a wireless communications device, periodic or aperiodic in-device interference mitigation is performed. At block 904, from the wireless communications device, wireless communications are conducted in response to the periodic or aperiodic in-device interference mitigation. In some embodiments, a frame that includes in-device interference information is generated, and the frame is wirelessly transmitted to a second communications device. In some embodiments, the frame includes a management frame or a control frame. In some embodiments, the in-device interference information is contained in a header of the frame or a frame body of the frame. In some embodiments, the in-device interference information includes a communications parameter restriction as a result of an existence or an occurrence of a wireless communications interference within the wireless communications device. In some embodiments, the communications parameter restriction includes a reception parameter restriction of the wireless communications device. In some embodiments, the reception parameter restriction includes a bandwidth (BW) restriction, a Modulation Coding Scheme (MCS) restriction, a reception power restriction, a number of spatial streams (Nss) restriction, and/or one or more interfered 20 Megahertz (MHz) channels that are covered by the wireless communications device's operating channel or a Basic Service Set (BSS) operating channel. In some embodiments, the communications parameter restriction includes a transmission parameter restriction for transmission to the wireless communications device. In some embodiments, the transmission parameter restriction includes a BW restriction, an MCS restriction, a transmission power restriction, an Nss restriction, and/or one or more interfered 20 Megahertz (MHz) channels that are covered by an operating channel of the wireless communications device or a Basic Service Set (BSS) operating channel. In some embodiments, the in-device interference information includes non-wireless activity service period (SP) information and optional transmission/reception parameter restriction within the non-wireless activity SP as a result of an existence or an occurrence of a wireless communications interference within the communications device. In some embodiments, the in-device interference information includes an availability or unavailability time announcement as a result of an existence or an occurrence of a wireless communications interference within the wireless communications device, and an availability announcement is contained in a header of the frame and an unavailability time announcement is contained in a frame body of the frame. In some embodiments, the frame is a control frame and a transmit opportunity (TXOP) subfield in a U_SIG field of a trigger based (TB) Physical Layer Protocol Data Unit (PPDU) carrying the frame is set per Short Interframe Space (SIFS) and the responding PPDU transmission time less than a duration of a soliciting initial control frame (ICF) frame. In some embodiments, the availability or unavailability time announcement is contained in a MAC header of the frame and is used to indicate a TXOP responder's available time. In some embodiments, the wireless communications device is compatible with an Institute of Electrical and Electronics Engineers (IEEE) 802.11 protocol. In some embodiments, the wireless communications device is a component of a multi-link device (MLD). The wireless communications device may be the same as or similar to an embodiment of the AP 106 depicted in FIG. 1, the APs 206-1, 206-2 depicted in FIG. 2, the wireless device 300 depicted in FIG. 3, and/or the wireless device 400 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A communications device comprising:
a controller configured to perform periodic or aperiodic in-device interference mitigation; and
a wireless transceiver configured to conduct wireless communications in response to the periodic or aperiodic in-device interference mitigation.

2. The communications device of claim 1, wherein the controller is further configured to generate a frame that comprises in-device interference information, and wherein the wireless transceiver is further configured to wirelessly transmit the frame to a second communications device.

3. The communications device of claim 2, wherein the frame comprises a management frame or a control frame.

4. The communications device of claim 2, wherein the in-device interference information is contained in a header of the frame or a frame body of the frame.

5. The communications device of claim 2, wherein the in-device interference information comprises a communications parameter restriction as a result of an existence or an occurrence of a wireless communications interference within the communications device, and wherein the frame comprises a management frame.

6. The communications device of claim 5, wherein the communications parameter restriction comprises a reception parameter restriction of the communications device.

7. The communications device of claim 6, wherein the reception parameter restriction comprises a bandwidth (BW) restriction, a Modulation Coding Scheme (MCS) restriction, a reception power restriction, a number of spatial streams (Nss) restriction, or one or more interfered 20 Megahertz (MHz) channels that are covered by the communications device's operating channel or a Basic Service Set (BSS) operating channel.

8. The communications device of claim 5, wherein the communications parameter restriction comprises a transmission parameter restriction for transmission to the communications device.

9. The communications device of claim 5, wherein the transmission parameter restriction comprises a bandwidth (BW) restriction, a Modulation Coding Scheme (MCS) restriction, a transmission power restriction, a number of spatial streams (Nss) restriction, or one or more interfered 20 Megahertz (MHz) channels that are covered by an operating channel of the communications device or a Basic Service Set (BSS) operating channel.

10. The communications device of claim 2, wherein the in-device interference information comprises non-wireless activity service period (SP) information and optional transmission/reception parameter restriction within the non-wireless activity SP as a result of an existence or an occurrence of a wireless communications interference within the communications device.

11. The communications device of claim 2, wherein the in-device interference information comprises an availability or unavailability time announcement as a result of an existence or an occurrence of a wireless communications interference within the communications device, and wherein an availability announcement is contained in a header of the frame and an unavailability time announcement is contained in a frame body of the frame.

12. The communications device of claim 11, wherein the frame is a control frame and a transmit opportunity (TXOP) subfield in a Universal Signal Field (U-SIG) field of a trigger based (TB) Physical Layer Protocol Data Unit (PPDU) carrying the frame is set per Short Interframe Space (SIFS) and the responding PPDU transmission time less than a duration of a soliciting initial control frame (ICF) frame.

13. The communications device of claim 1, wherein the communications device comprises a mobile wireless access point (AP) or a wireless non-AP station (STA).

14. The communications device of claim 1, wherein the communications device comprises a wireless device that is compatible with an Institute of Electrical and Electronics Engineers (IEEE) 802.11 protocol.

15. The communications device of claim 1, wherein the communications device comprises a wireless multi-link device (MLD), and wherein the wireless transceiver is further configured to transmit a frame to a second wireless MLD through a wireless link between the wireless MLD and the second wireless MLD in response to the periodic or aperiodic in-device interference mitigation.

16. A communications device comprising:
a controller configured to generate a frame that comprises in-device interference information contained in a header of the frame or a frame body of the frame, wherein the frame comprises a management frame or a control frame; and
a wireless transceiver configured to wirelessly transmit the frame to a second communications device.

17. The communications device of claim 16, wherein the in-device interference information comprises a communications parameter restriction, wireless local area network (WLAN) activity service period (SP) information, or an availability or unavailability time announcement as a result of an existence or an occurrence of a wireless communications interference within the communications device.

18. The communications device of claim 16, wherein the communications device comprises a wireless access point (AP) that is compatible with an Institute of Electrical and Electronics Engineers (IEEE) 802.11 protocol.

19. A method for wireless communications, the method comprising:
at a wireless communications device, performing periodic or aperiodic in-device interference mitigation; and
from the wireless communications device, conducting wireless communications in response to the periodic or aperiodic in-device interference mitigation.

20. The method of claim 19, wherein the wireless communications device is compatible with an Institute of Electrical and Electronics Engineers (IEEE) 802.11 protocol.
